(19) United States
(12) Patent Application Publication
(10) Pub. No.: US 2022/0156690 A1
(43) Pub. Date: May 19, 2022

(54) PACKAGE DELIVERY SECURITY

(71) Applicants: Steve U. Morales, Garner, NC (US); Cynthia K. Restivo, Diamondhead, MS (US)

(72) Inventors: Steve U. Morales, Garner, NC (US); Cynthia K. Restivo, Diamondhead, MS (US)

(21) Appl. No.: 16/951,375

(22) Filed: Nov. 18, 2020

(51) Int. Cl. G06Q 10/08; G06Q 50/00; G06Q 40/02; G06Q 20/34; G06F 16/28; H04L 12/58

(52) U.S. Cl. CPC G06Q 10/0836; G06Q 50/01; G06Q 10/0838; H04L 51/32; G06Q 20/34; G06F 16/285; G06Q 40/02

(57) ABSTRACT

A system and method for preventing theft and hold safely one or more unattended packages left outside of a home after being delivered when the package recipient is not present, wherein the network of trusted neighbors are registered using an app and are within close proximity of one another's homes, and of which a package recipient can communicate with their trusted neighbors in the network and request their unattended package be picked up and held safely while being compensated.

### COPYRIGHT NOTICE

A portion of the disclosure of this patent contains material that is subject to copyright protection. The copyright owner has no objection to the reproduction by anyone of the patent document or the patent disclosure as it appears in the Patent and Trademark Office patent files or records, but otherwise reserves all copyright rights whatsoever.

### BACKGROUND OF THE INVENTION

### Field of the Invention

The present invention relates to a system and method for protecting delivered packages left outside a person's home. More specifically, the present invention relates to a network of individuals who can take the delivered package(s) and hold onto it (them) safely until the intended recipient has returned home in order to prevent the delivered package(s) from being stolen by a “porch pirate”.

### Description of Related Art

The event of online shopping in recent years for retail sales, groceries, and the like has led to an increased average number of packages delivered to individual's homes. Theft is one potential problem that exists in the home delivery of packages that arrive when the homeowner is not home, at work, running errands, and the like. The result of the increased volume of packages left unattended until the homeowner returns has led to the crime of so-called porch piracy. According to a CNBC report, “an estimated 36% of Americans have had a package stolen from outside their home at least once”. It is also known that 2 in 5 U.S. consumers receive 1 to 2 packages each week from Amazon alone.

A number of methods have been developed, all of which have shortcomings. One being the necessity of having to request that the delivery service hold the package for pickup. This partially defeats the benefits of home delivery if one needs to retrieve the package from the delivery carrier's hub/warehouse.

Another method exhibiting a shortcoming is the availability of a variety of lock boxes that can be purchased and left outside of the home for placement of delivered packages. The problem with a lockbox is the accessibility by the delivery person if the box is locked upon arrival. Furthermore, there could be a problem if the delivery person needs to lock the box, or if the delivery person forgets to lock it. In addition, the presence of a lockbox is essentially an advertisement that there could be a package inside, inviting theft of the entire lockbox. Lastly, some delivery companies ask for a key to gain entry into an individual's home for the purpose of leaving the delivered package(s) inside. This method could invite theft of the homeowner's key and/or items inside the home and it is difficult to prevent such occurrences from happening.

Accordingly, there is clearly a need to know a package(s) is secure once delivered to the outside of the home without fear of it/them being stolen, and that also does not have the limitations of the prior art.

### BRIEF SUMMARY OF THE INVENTION

The present invention relates to a system and method for preventing the theft of packages from front porches or outside of homes when no one is home, avoiding the problems in the prior art. The system involves a peer to peer system creating a network of trusted neighbors so that if a package is being delivered, a package recipient can contact one of the trusted neighbors within the network to pick up the delivered package that the recipient can obtain from them later or for re-delivery by the trusted neighbor. The trusted neighbor is rewarded by a service payment made by the package recipient.

Accordingly, in one embodiment, there is a system to prevent theft of a package recipient's unattended package left outside of the recipient's home comprising:
a) an assembled list of trusted neighbors of the package recipient;
b) a system for communicating with a single trusted neighbor who picks up the unattended package;
c) a system of returning the package to the package recipient;
d) a system to take the package recipient's credit card information; and
e) a system to pay a trusted neighbor who has picked up the unattended package.

In another embodiment, there is a method of preventing theft of a package recipient's unattended package left outside of the recipient's home comprising:
a) assembling a group of trusted neighbors of the package recipient;
b) the package recipient communicating with one of the trusted neighbors to pick up the unattended package;
c) the trusted neighbor obtaining the unattended package located at the recipient's home;
d) the package recipient picking up the package held by the trusted neighbor by one of picking up the unattended package from the neighbor and the trusted neighbor delivering the unattended package back to the recipient; and
e) the package recipient paying the trusted neighbor.

### BRIEF DESCRIPTION OF THE DRAWINGS

FIG. 1 is a relationship chart of the system of the present invention.

FIG. 2 is a flowchart of the method of the present invention.

### DETAILED DESCRIPTION OF THE INVENTION

While this invention is susceptible to embodiment in many different forms, there is shown in the drawings, and will herein be described in detail, specific embodiments with the understanding that the present disclosure of such embodiments is to be considered as an example of the principles and not intended to limit the invention to the specific embodiments shown and described. In the description below, like reference numerals are used to describe the same, similar, or corresponding parts in the several views of the drawings. This detailed description defines the meaning of the terms used herein and specifically describes embodiments in order for those skilled in the art to practice the invention.

### Definitions

The terms “about” and “essentially” mean±10 percent.

The terms “a” or “an”, as used herein, are defined as one or as more than one. The term “plurality”, as used herein, is defined as two or as more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

The term “comprising” is not intended to limit inventions to only claiming the present invention with such comprising language. Any invention using the term comprising could be separated into one or more claims using “consisting” or “consisting of” claim language and is so intended.

Reference throughout this document to “one embodiment”, “certain embodiments”, “an embodiment”, or similar terms means that a particular feature, structure, or characteristic described in connection with the embodiment is included in at least one embodiment of the present invention. Thus, the appearances of such phrases in various places throughout this specification are not necessarily all referring to the same embodiment. Furthermore, the particular features, structures, or characteristics may be combined in any suitable manner in one or more embodiments without limitation.

The term “or”, as used herein, is to be interpreted as an inclusive or meaning any one or any combination. Therefore, “A, B, or C” means any of the following: “A; B; C; A and B; A and C; B and C; A, B, and C”. An exception to this definition will occur only when a combination of elements, functions, steps, or acts are in some way inherently mutually exclusive.

The drawings featured in the figures are for the purpose of illustrating certain convenient embodiments of the present invention and are not to be considered as limitation thereto. The term “means” preceding a present participle of an operation indicates a desired function for which there is one or more embodiments, i.e., one or more methods, devices, or apparatuses for achieving the desired function and that one skilled in the art could select from these or their equivalent in view of the disclosure herein, and use of the term “means” is not intended to be limiting. The method claims are not intended to be sequential. Where practical, the steps may be performed in any order.

As used herein, the term “theft of a package” refers to the actions of one or more porch pirates (i.e., a thief) illegally taking a package from a recipient, the package having been left unattended on the porch or other outside location of recipient's home after the package has been delivered to the recipient.

As used herein, the term “unattended package” refers to a package being left unattended by a delivery service at a recipient's location when the recipient is not present.

As used herein, the term “outside the recipient's home” refers to the front porch of recipient's home or any other outside place where a delivered package can be delivered and left unattended.

As used herein, the term “home” means any place a person receives a delivered package where the package recipient may not be present to receive the package, thus causing the delivered package to be left outside and unattended.

As used herein, the term “list of trusted neighbors” refers to individual participants in the network who take and safely hold onto a delivered package in order to prevent theft of a package, who are close enough in proximity to the unattended package to be able to go to the location of the delivered package and take the package. The list includes people who have in some manner been vetted such as being a friend of the package recipient, having background checks performed, and the like. In one embodiment, a list is compiled through a software application by individuals who sign up for the network system through the software application. The software application can then aid the recipient in choosing a neighbor to be trusted. Neighbor refers to individuals relatively close in proximity to the home of the package recipient. The software application is coordinated by information on a server.

As used herein, the term “package recipient” refers to the owner of the unattended package.

As used herein, the term “system of communicating” refers to any means of communication for the package recipient to communicate with one or more trusted neighbors. Examples include use of phone or texting, emails, phone app notifications, and the like.

As used herein, the term “pick up or obtaining” refers to the selected trusted neighbor going to the package recipient's home or other location and taking and holding safely the unattended package until it can be delivered to or picked up by the package recipient.

As used herein, the term “credit card information” refers to providing the package recipient's credit card information so it can be charged for payment of the pickup of the delivered package(s) by the trusted neighbor. Credit card also generically refers to other payment means including, checks, debit cards, and the like.

As used herein, the term “pay a trusted neighbor” refers to the package recipient paying the trusted neighbor for the pickup of the delivered package(s). It is also contemplated that a software application coordinating such transactions will add their fees to the process at the same time or later.

As used herein, the term “assembled over the internet through a software application (app)” refers to the system and method of the present invention being placed online and controlled by a user with an application on a computer, a smart phone, a tablet, or the like, which functions to provide sign up selection, payments, communication, and the like.

As used herein, the term “delivering the unattended package” refers to either the package recipient picking up the package from the trusted neighbor in the network or the trusted neighbor delivering the package back to the package recipient.

### DRAWINGS

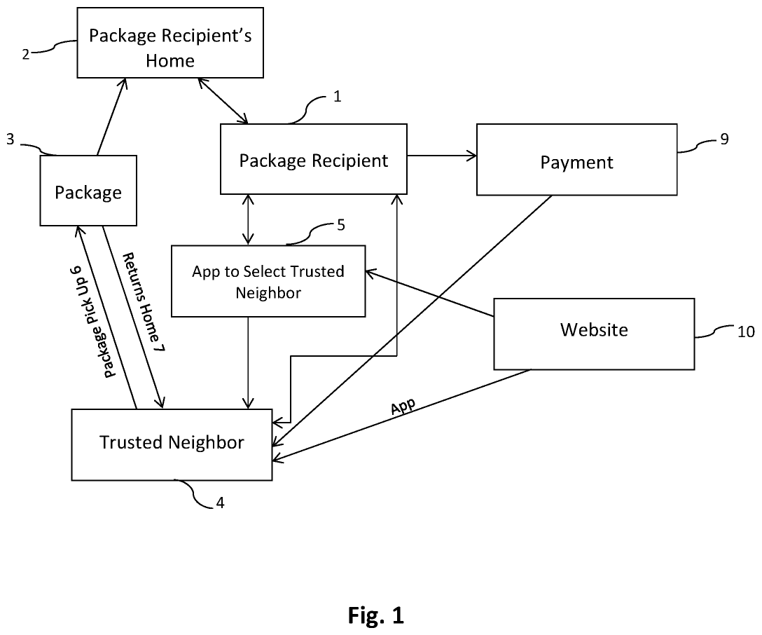

Now referring to the drawings, FIG. 1 is a representation of the relationship of the parts of the system of the present invention. A package recipient 1 is not at package recipient's home 2. During that time, a package 3 is left outside of package recipient's home 2 where it could be stolen by porch pirates. Once package recipient 1 finds out there has been a delivery (e.g., doorbell camera or digital delivery notice to a smart phone, tablet, or the like), the package recipient 1 communicates through an app 5 with a trusted neighbor 4 who goes 7 to package recipient's home 2 and picks up 6 the unattended package(s) 3 and returns home 7 to hold the package(s) 3 safely until the package recipient 1 is available. Once the package recipient 1 is available, the package recipient 1 picks up the package 3 from the trusted neighbor 4 or the trusted neighbor 4 delivers the package 3 to the package recipient 1. The package recipient 1 then makes a payment 9 to the trusted neighbor 4. In one embodiment, where a website 10 is involved, any aspect of the system may pass through the website 10.

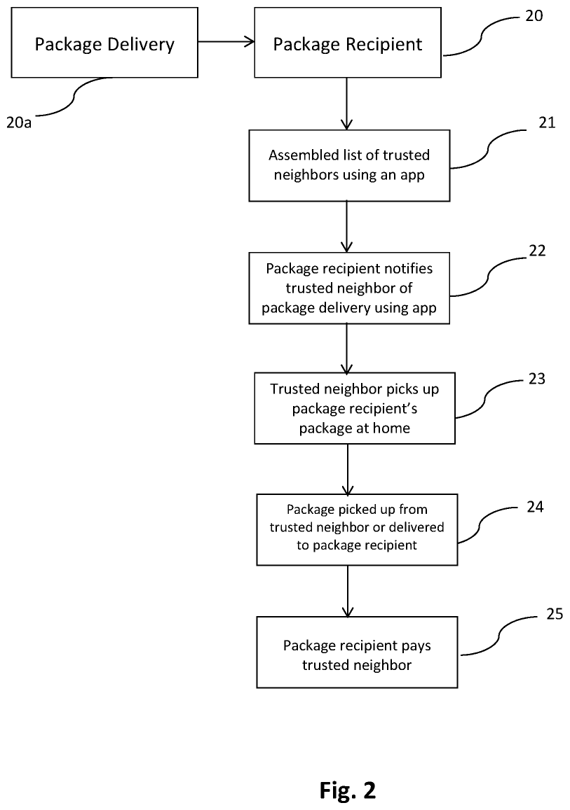

FIG. 2 is a flowchart of the method of the present invention. The order of steps can be different, if desired. Package recipient 20 has a package 20a left unattended at package recipient's house. The package recipient 20 assembles or has assembled a group of trusted neighbors using an app 21. Once a package is delivered, the package recipient notifies one trusted neighbor on the app 22 and the trusted neighbor picks up the package at recipient's home 23. Once package recipient is available, the package is picked up from the trusted neighbor by the package recipient or the trusted neighbor delivers the package to the recipient 24. Lastly, the package recipient 20 then pays the trusted neighbor 25 for their service.

Those skilled in the art to which the present invention pertains may make modifications resulting in other embodiments employing principles of the present invention without departing from its spirit or characteristics, particularly upon considering the foregoing teachings. Accordingly, the described embodiments are to be considered in all respects only as illustrative, and not restrictive, and the scope of the present invention is, therefore, indicated by the appended claims rather than by the foregoing description or drawings. Consequently, while the present invention has been described with reference to particular embodiments, modifications of structure, sequence, materials, and the like apparent to those skilled in the art still fall within the scope of the invention as claimed by the applicant.

What is claimed is:

1. A system to prevent theft of a package recipient's unattended package left outside of the recipient's home comprising:
a) an assembled list of trusted neighbors of the package recipient;
b) a system for communicating with a single trusted neighbor who picks up the unattended package;
c) a system of returning the package to the package recipient;
d) a system to take the package recipient's credit card information; and
e) a system to pay a trusted neighbor who has picked up the unattended package.

2. The system to prevent theft of a package according to claim 1 wherein the list of trusted neighbors is assembled using an app.

3. The system to prevent theft of a package according to claim 1 wherein the system of communicating is by one of phone, text, email, and phone app notification.

4. The system to prevent theft of a package according to claim 1 wherein a credit card of the package recipient is used to pay the trusted neighbor.

5. The system to prevent theft of a package according to claim 1 wherein the trusted neighbor returns the package to the package recipient or the package recipient picks up the package from the trusted neighbor.

6. A method of preventing theft of a package recipient's unattended package left outside of the recipient's home comprising:
a) assembling a group of trusted neighbors of the package recipient;
b) the package recipient communicating with one of the trusted neighbors to pick up the unattended package;
c) the trusted neighbor obtaining the unattended package located at the recipient's home;
d) the package recipient picking up the package held by the trusted neighbor by one of picking up the unattended package from the neighbor and the trusted neighbor delivering the unattended package back to the recipient; and
e) the package recipient paying the trusted neighbor.

7. The method of preventing theft of a package recipient's unattended package according to claim 6 wherein the list of trusted neighbors is assembled using an app.

8. The method of preventing theft of a package recipient's unattended package according to claim 6 wherein the method of communicating is by one of phone, text, email, and phone app notification.

9. The method of preventing theft of a package recipient's unattended package according to claim 6 wherein a credit card of the package recipient is used to pay the trusted neighbor.
